(19) United States
(12) Patent Application Publication
(10) Pub. No.: US 2022/0258675 A1
(43) Pub. Date: Aug. 18, 2022

(54) Evidence Storage Container for Vehicle

(71) Applicant: Jeffrey H. Steinkamp, Quincy, IL (US)

(72) Inventor: Jeffrey H. Steinkamp, Quincy, IL (US)

(21) Appl. No.: 17/671,340

(22) Filed: Feb. 14, 2022

Related U.S. Application Data
(60) Provisional application No. 63/148,848, filed on Feb. 12, 2021.

(51) Int. Cl. B60R 9/055; B60R 11/00; B60R 9/048

(52) U.S. Cl. CPC B60R 9/055; B60R 11/00; B60R 9/048; B60R 2011/0094; B60R 2011/0066; B60R 2011/0077; B60R 2011/007

(57) ABSTRACT

An evidence storage container is configured to be either removably or permanently attached to a law enforcement vehicle to secure seized items that may serve as evidence. The evidence storage container has a paper grasp structure for holding currency, driver's licenses, or other items of paper, as well as provisions to store a pen or pencil and drain holes to drain any moisture from precipitation.

### CROSS-REFERENCE TO RELATED APPLICATIONS

The present application claims priority from, and incorporates by reference in its entirety, U.S. provisional patent application 63/148,848 filed Feb. 12, 2021.

### BACKGROUND

### Field of the Invention

The present invention relates to equipment for law enforcement officials, and more particularly, to a storage container for a vehicle that stores and secures evidence acquired by a law enforcement officer during a traffic stop.

### Description of Related Art

When a law enforcement officer (LEO) detains a person during a traffic stop the LEO will routinely handcuff the detained person and physically search the person's pockets, hat, purse, backpack, or other clothing. The purpose of this physical search is to determine if the detained person is in possession of any illegal weapons, illegal drugs or alcohol, drug paraphernalia, contraband, stolen merchandise, or the like. This body search is for the safety of both the LEO and the detained person and to determine if further legal action by the LEO is warranted.

If one or more items of interest are found and the items are not thought to be dangerous—open alcohol containers or items suspected of being stolen—the LEO often lays the items on the ground or on a nearby curb in order to continue searching the detained person.

### BRIEF SUMMARY OF THE INVENTION

Physical searches during a traffic stop and detainment typically take place in front of the LEO's law enforcement vehicle. This position provides safety for the LEO and also allows the LEO's dashboard camera to record the actions of the traffic stop and subsequent activities for future review. If items of interest are found that are potentially dangerous—e.g., illegal weapons, illegal drugs, drug paraphernalia—the LEO will often temporarily place these possible evidence objects into their own pockets or just hold them in their hands until the LEO has the time and opportunity to put the object(s) in a designated evidence bag. The present inventor recognized the drawbacks of handling potential evidence objects in this manner. The various embodiments disclosed herein overcome these drawbacks by providing a convenient, safe and secure evidence storage container that preserves the chain of custody for the potential evidence objects.

### DESCRIPTION OF THE DRAWINGS

The accompanying drawing, which is incorporated in and constitutes part of the specification, illustrate various embodiments of the invention. Together with the general description, the drawings serve to explain the principles of the invention. In the drawings:

FIG. 1 depicts a perspective view of an evidence storage container located on the hood of a law enforcement vehicle according to various embodiments of the invention.

FIG. 2 depicts front views and perspective views of some of the various evidence storage container embodiments disclosed herein.

FIG. 3 is a perspective view of an evidence storage container with drain slots according to various embodiments of the present invention.

FIG. 4 is a perspective view of an evidence storage container with a pencil holder according to various embodiments of the present invention.

FIG. 5 is a perspective view of an evidence storage container with a slit configured to secure plastic cards, credit cards, driver's license card, currency or other items according to various embodiments of the present invention.

FIG. 6 is a perspective view of an evidence storage container embossed in a vehicle hood according to various embodiments of the present invention.

FIG. 7 depicts a front view and a top view of two embodiments shown in FIG. 2.

### DETAILED DESCRIPTION

The present inventor noted that, upon discovering various physical items such as illegal weapons, illegal drug or alcohol, drug paraphernalia, contraband and/or stolen merchandise, the LEO is in need of a convenient, safe and secure place or location to temporarily store the items which may possibly serve as evidence. Keeping the seized items in a safe and secure place may be necessary in order to maintain a chain of custody so the items can be used as evidence in a later legal proceeding. At the same time, the items need to be kept safe and secure while the LEO is maintaining control and custody of the detained person. Moreover, any items taken from the detained person should be kept away from the other people who may happen to be near the detainment, including for example, the detained person's wallet, money, jewelry, cell phone or other items of value. The present inventor recognized that it can sometimes be dangerous for the LEO to place seized items in his pockets or on the street or curb. This is especially true when dealing with uncapped drug syringes, open pills, drug baggies, small sharp weapons, firearms, glass containers, or other potentially dangerous items such as cocaine, heroin or fentanyl.

The LEO will sometimes place seized items on the hood, trunk or top of the LEO's law enforcement vehicle. However, since the hood, trunk or top of the law enforcement vehicle are often not completely flat, these objects can sometimes roll around or slide off the vehicle. Moreover, unsecured objects, such as a driver's license, proof of insurance documents and paper currency can easily be blown by the wind off the hood, trunk or top of the law enforcement vehicle. The conventional situation for handling seized items by placing them on the law enforcement vehicle or holding them in the LEO's pockets is less than ideal and can quickly become an inconvenience or even a distraction for the LEO. Such a situation could possibly place the LEO in a compromised and unsafe position if dealing with both a distraction and the detained person, and also possibly dealing with people who happen to be nearby. The various embodiments disclosed herein have been developed to eliminate such problems and provide a container system that allows a safe and convenient location to properly store and secure evidence items during traffic stops while maintaining the chain of custody for seized items.

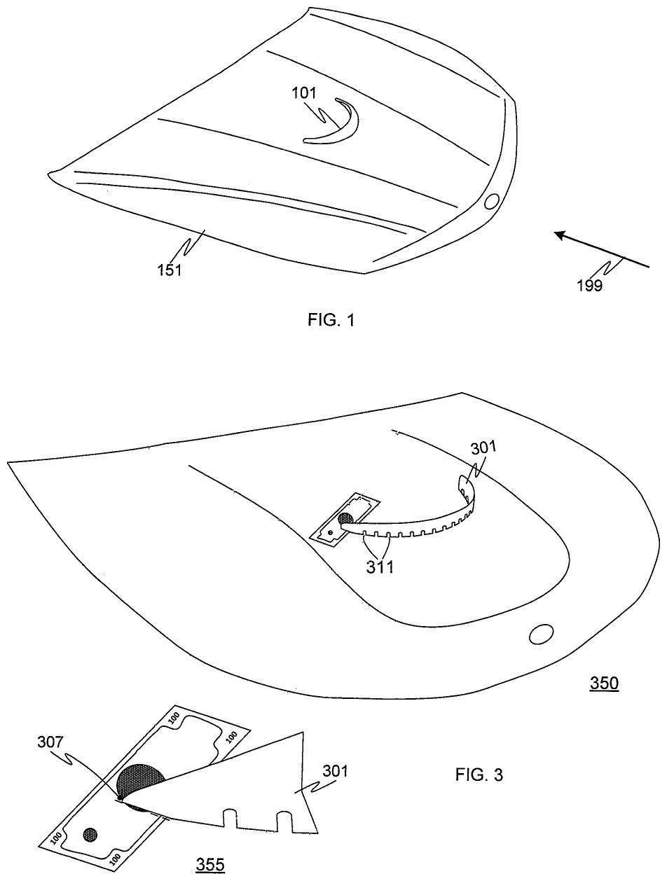

FIG. 1 is a perspective view of evidence storage container 101 located on the hood 151 of a law enforcement vehicle according to various embodiments of the invention. In accordance with various embodiments the evidence storage container for securing seized items may be either rigid or collapsible. The underside of the rigid version may be curved or shaped to match the contour of the vehicle. In some embodiments the underside of the evidence storage container 101 may be flexible, allowing it to conform to the hood 151 or other part of a law enforcement vehicle. The collapsible version of the evidence storage container can be folded up and stowed in the glove box, under the seat or other place of convenience within the law enforcement vehicle. The embodiment illustrated in FIG. 1 is a rigid version of generally semi-circular shape.

The evidence storage container may be positioned at various safe and convenient positions on the law enforcement vehicle or other appropriate vehicle. In some implementations the evidence storage container is attached to the hood as shown in FIG. 1. Other implementations of the evidence storage container may be attached to the top of the vehicle, the trunk, or to other parts of the of the law enforcement vehicle. For example, in some implementations the evidence storage container may even be attached inside the law enforcement vehicle, e.g., to the dashboard. It can be advantageous in establishing the chain of custody for a seized item to have it held in view of the dashboard camera of the law enforcement vehicle. This may be achieved by attaching the evidence storage container to the hood in view of the camera as depicted in FIG. 1.

Depending upon the requirements of the implementation, embodiments of the evidence storage container may be constructed from one or more of rubber, plastic, metal, wood, glass, carbon fiber, fiberglass, leather, cloth, or other such substances known to those of ordinary skill in the art. Various implementations of the evidence storage container include a wide array of colors such as clear, black, white, camouflage and transparent, or other colors. Some implementations of the evidence storage container are provided in colors to match or coordinate with the law enforcement vehicle.

The various embodiments of the evidence storage container are designed to be either removably attached or permanently attached to the law enforcement vehicle used by a LEO or other type vehicle. The means for removably attaching the evidence storage container to the vehicle may include structure such as magnets, hook and loop fasteners (e.g., Velcro™), double backed adhesive tape, one sided tape, weak adhesives, screws, bolts, or other like types of removable attachment structures known to those of ordinary skill in the art. Some embodiments may have a bracket that is permanently attached to the vehicle, allowing the evidence storage container to fit in the bracket. In other embodiments the evidence storage container may be permanently attached to the vehicle with structure such as rivets, welding, soldering, glue, contact cement, caulking, or other like types of permanent attachment structures known to those of ordinary skill in the art.

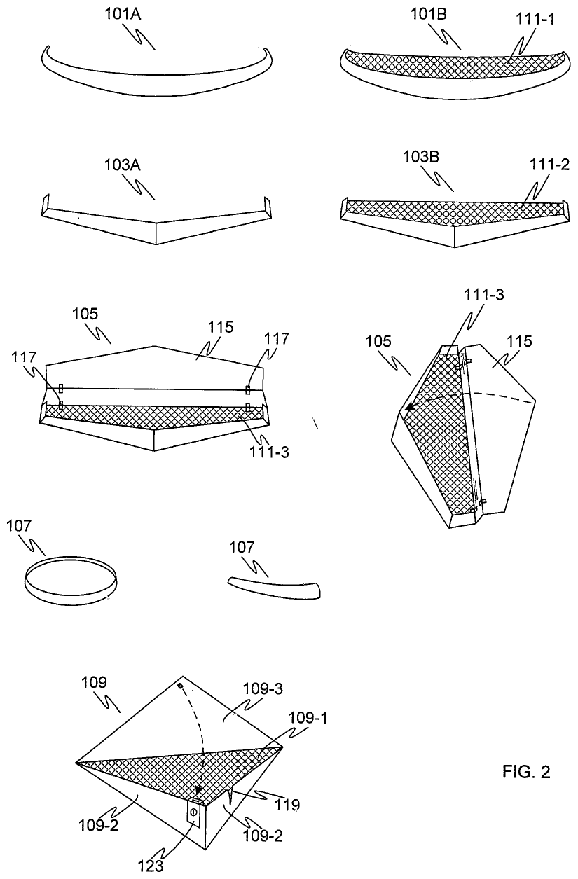

FIG. 2 depicts front views and perspective views of some of the various evidence storage container embodiments disclosed herein. Evidence storage container 101A shown in FIG. 2 is similar in shape to 101 of FIG. 1 as viewed from direction 199 shown in FIG. 1. The direction 199 of FIG. 1 is from in front of the vehicle facing towards the vehicle. Other evidence storage container embodiments have various shapes, including round, square, crescent, rectangular, oval, or multi-sided shape with a possible aerodynamic profile. Evidence storage containers 101A-B, 103A-B, 105, 107 and 109 of FIG. 2 show some examples of the various shaped embodiments.

Evidence storage container 101B of FIG. 2 is similar in shape to 101 of FIG. 1, but has a bottom portion 111-1. The bottom portion 111-1 of evidence storage container 101B may have one or more magnets or weak adhesives or other types of attachment structures on its bottom surface so that it can be attached to the vehicle either removably or permanently. For embodiments with removable attachment structures, the bottom portion 111-1 allows the evidence container 101B to be detached from the vehicle and moved to another location such as inside the vehicle or into the vehicle's trunk. In this way seized items can be moved without the need for the LEO to handle them.

Evidence storage container 103A is an implementation shaped with straight lines rather than curves. The particular shape may be chosen by a user to match the vehicle, or to best fit within a storage space in the vehicle (e.g., the glove box, door pockets or within the vehicle's trunk), or may be chosen based on the user's personal preferences. Evidence storage container 103B is similar in shape to 103A, but it provided with bottom portion 111-2. The evidence container bottom portions (e.g., 111-1, 111-2 and 111-3) may be made from a flexible material in order to conform to the portion of the vehicle that it is place on. In this way the bottom portion could conform to the shape of the vehicle hood and also conform to the shape of the vehicle top or trunk which may have a surface of a somewhat different shape.

Evidence storage container 105 is shown in two views in FIG. 2 to illustrate the hinged lid 115. Evidence storage container 105 is shaped similar to evidence storage containers 103A and 103B, but 105 has a hinged lid 115 and back panel 113. The hinged lid 115 and back panel can be folded back to an open position while the container is being used during the physical search of a detained suspect. If seized items are to be stored—for example, while being taken to a police station—the hinged lid 115 and back panel 113 can be moved to a closed position to secure the seized items within evidence storage container 105. In this way the LEO can simply pick up the closed evidence storage container 105 with seized items inside, and store it within the law enforcement vehicle. The hinged lid 115 and back panel 113 are shown in FIG. 2 connected with hinges 117. Other structures may be used for hinge mechanisms, including for example, a piano hinge extending fully or partially across the hinging edge, a piece of flexible plastic or rubber, a piece of cloth, or any other hinging mechanism known to those of ordinary skill in the art. Any of the various shaped embodiments may be equipped with a hinged lid and back panel.

Evidence storage container 107 of FIG. 2 is an oval shaped container. Other implementations may be round instead of oval. FIG. 2 provides two views of evidence storage container 107—a perspective view looking (in direction 199 of FIG. 1) from the front and a side view. The wall towards the front of evidence storage container 107 (i.e., oriented towards the front of the vehicle) is taller than the wall towards the back of the container. This is done because the vehicle hood generally slopes downward towards the front, and for aesthetic purposes for the evidence containers that are permanently attached to the vehicle. In practice, however, the back side may be taller than the front, or all sides can be of equal height, depending upon the requirements of the implementation, the slope of the vehicle where the container is to be attached, and the preferences of the user.

Evidence storage container 109 of FIG. 2 has a bottom panel 109-1, side panels 109-2 and a lid 109-3 connected by a hinging mechanism. In this particular implementation the side panels 109-2 are triangular in shape, avoiding the need for a back panel as is provided for evidence storage container 105. Evidence storage container 109 also has a security attachment mechanism 123 embodied as a latch that uses a key to lock and unlock.

FIG. 3 is a perspective view of an evidence storage container 301 with drain slots 311 according to various embodiments of the present invention. View 350 depicts the evidence storage container 301 mounted on vehicle hood 152. Since traffic stops and detainments typically take place outdoors on the side of a road or street there may be inclement weather to deal with. Rain or snow may result in moisture within the evidence storage containers. Some of the various embodiments may include one or more drain holes 311 or grooves to empty condensation, rainwater, melting snow/ice, or other moisture from the device. Providing a drain hole or groove helps to maintain a dry area for evidence storage, thus preserving the seized items.

Some embodiments may be configured to have a paper grasp structure in the form of a wedge section 307 that leaves a slight gap between the hood of the vehicle and one or both tips of the evidence storage container so that the tip of the container is positioned above the vehicle's hood by approximately ⅛ inch. View 355 of FIG. 3 depicts a cutaway portion of evidence storage container 301 to illustrate the wedge section 307. The gap may extend inward, sloping down towards the hood, for approximately ½ to 1 inch to the point where the container meets the hood. The purpose of the gap is to provide a place for a LEO to wedge papers, money, credit cards, driver's licenses, photo IDs, illegal drugs, a clear plastic bag holding small items, or small pieces of evidence that could easily be lost or blown away. In another embodiment a slot 119 is provided on the side of the container for the same purpose as shown in FIG. 2. The slot 119 is arranged such that a small plastic evidence bag can be temporarily wedged into it to avoid losing pieces of evidence or having them blown away. An added advantage of using a small plastic evidence bag is that it shields the stored evidence from the elements, e.g., rain, snow, etc., and also keeps evidence in sight during the traffic stop, thus helping to preserve the chain of custody. In another embodiment a clip 121 is provided as shown in FIG. 2. Clip 121 can be used to hold papers, currency, or a bag for holding small items of evidence. The wedge section 307, slot 119 and clip 121 are examples of paper grasp structures for holding documents, currency or small items of evidence. While these elements are called “paper” grasp structures, they are well suited to holding small items of evidence such as needles, driver's licenses (which may be plastic), plastic bags for holding small items, or other non-paper seized items.

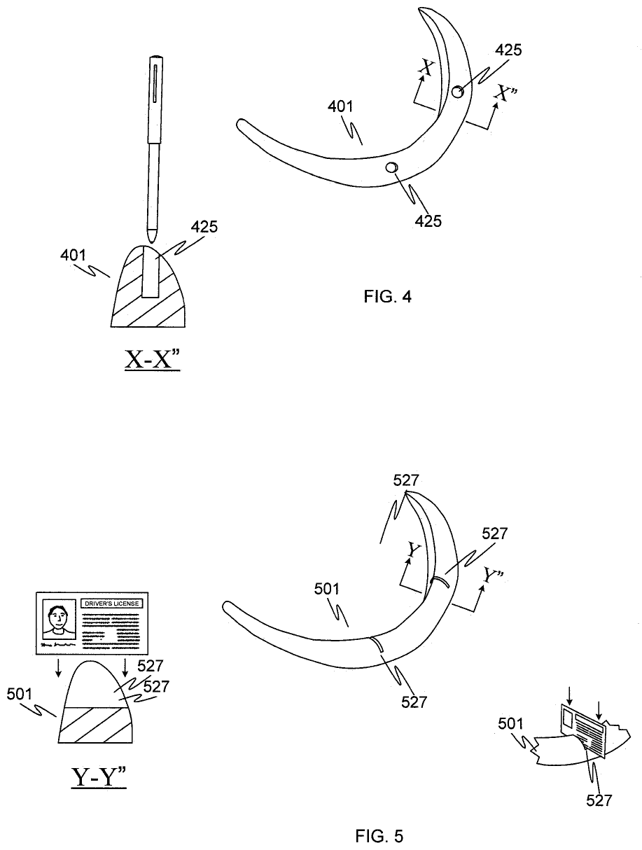

FIG. 4 is a perspective view of evidence storage container 401 with a pencil holder 425. This hole can be used to securely hold a pen or pencil, or to hold any other small cylindrical item. View X-X″ of FIG. 4 is a section view of evidence storage container 401 taken along the line X-X″ showing the pencil holder hold 425.

FIG. 5 is a perspective view of evidence storage container 501 with a license holder slit 527 configured to secure the detained person's driver's license card, plastic cards, credit cards, currency or other items or papers. View Y-Y″ of FIG. 5 is a section view of evidence storage container 501 taken along the line Y-Y″ showing the license holder slit 527.

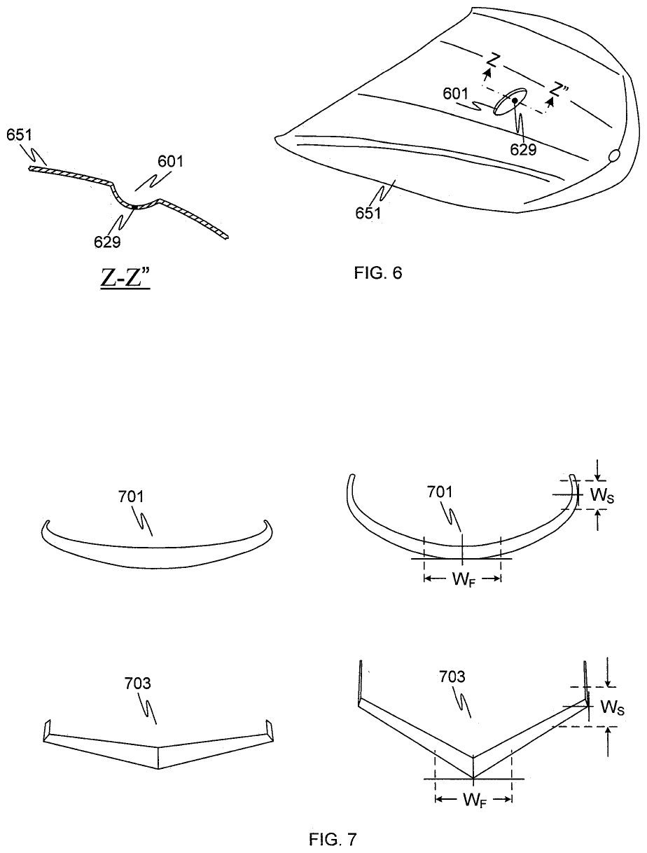

FIG. 6 is a perspective view of an evidence storage container 601 embossed in a vehicle hood according to various embodiments of the present invention. In some embodiments the evidence storage container 601 may be implemented as a depression or pocket that is formed, stamped or welded in the hood, top, or trunk of the vehicle to accommodate evidence removed by a LEO from a suspect. The depression or pocket, shown in FIG. 6 may be formed at the time of manufacturing of the vehicle part, and can either be an optional part of the vehicle at the time of purchase or be an after-market part sold directly to police departments—e.g., an after-market vehicle hood.

This depressed, sunken pocket may be, but is not limited to, the generally semi-circle, round, square, rectangular, oval, crescent, or multi-sided shape. This depression may be of assorted physical length, depth, width and shape. The depressed, sunken pocket may be configured with a drain hole system of one or more holes, slots or a screen to drain water, rain, condensation, snow, etc. The drain hole system may be built into the depressed, sunken pocket and configured to empty to the ground beneath the vehicle.

FIG. 7 depicts a front view and a top view of two embodiments shown in FIG. 2—evidence storage container 101A and evidence storage container 103A. In FIG. 7 the containers are labeled evidence storage containers 701 and 703. Due to the variety of shapes of the various evidence storage container embodiments, a definition of the phrases “front wall portion” and “side wall portion” is warranted. FIG. 7 is provided to explain and define as these phrases, as used herein.

The front views of evidence storage containers 701 and 703 (on the right side of FIG. 7) are from the perspective of viewing in direction 199 of FIG. 2. The top view of evidence storage containers 701 and 703 are shown on the right side of FIG. 7. As shown in the top view of evidence storage container 701, the width of the front wall W_{F} is one-third the overall width of the evidence storage container 701. For evidence storage container embodiments with a flat section of its front face greater than one-third the overall width and oriented perpendicular to direction 199, the whole flat section perpendicular to direction 199 is considered the front face. The front face is centered about the forward most point of the evidence storage container 701, unless the forward-most point is within one-sixth of the width from a side. If the forward-most point is within one-sixth of the width from a side, then the edge of the front face is defined by that side.

Since evidence storage containers 701 and 703 are symmetrical as viewed from the front (and don't have a wide flat spot), the front wall portions of each consist of the center one-third section of evidence storage containers 701 and 703. The width and location of the side wall portions are defined in a similar manner. However, evidence storage containers 701 and 703 are not symmetrical as viewed from the side. Therefore, the side wall portions are not centered about the side of evidence storage containers 701 and 703. Instead, the side wall portion of evidence storage container 701 has a width W_{S} equal to one-third the width of the side, but is shifted towards the back of the evidence storage container 701. In this way the side wall portion is centered about the point of evidence storage container 701 that extends furthest to the side. The width and location of the side walls evidence storage container 703 are determined in a similar manner. The portion of evidence storage containers 701 and 703 between the front wall portion and the side wall portion is considered a corner.

The phrase “removably attached” as used herein means that an item is attached to another item in a manner that allows the user to easily detach the two items without damaging either item or the structure for attaching the items. A refrigerator magnet can be removably attached to a refrigerator. A Post-it™ note uses a weak adhesive that can be removably attached to a desk. A threaded nut can be removably attached to a bolt. Two pieces of metal welded together, or two boards glued together are not removably attached to each other. Two items that are “permanently attached”, as this phrase is used herein, cannot be taken apart without damaging either one or more of the attached items or the structure used to attach them. Examples of structures used to permanently attach two items include rivets, welding, soldering, glue, contact cement, caulking, or other like types of permanent attachment structures known to those of ordinary skill in the art. A “security attachment mechanism”, as this phrase is used herein, allows an item to be locked to another item in a removably attachable manner. For example, a padlock and hasp can be used as a security attachment mechanism to lock a door to a door frame. A latch that has a combination lock or requires a key is another example of a security attachment mechanism.

What is claimed is:

1. An evidence storage container for a law enforcement vehicle, the evidence storage container comprising:
a front wall portion with a maximum front wall height and a front lower edge;
at least one side wall portion attached to the front wall portion, the at least one side wall portion having a sidewall lower edge;
the front lower edge and the sidewall lower edge comprising a vehicle contour edge section having a contour that matches a surface on the law enforcement vehicle, the vehicle contour edge section being at least 25% a length of the evidence storage container; and
an attachment structure affixed to the law enforcement vehicle.

2. The evidence storage container of claim 1, wherein the at least one side wall portion includes two side wall portions; and
wherein each of the two side wall portions has a sidewall height which is less than the maximum front wall height.

3. The evidence storage container of claim 1, wherein the attachment structure is a removable attachment structure configured to removably attach the evidence storage container to the law enforcement vehicle.

4. The evidence storage container of claim 3, wherein the removable attachment structure is a magnetic strip.

5. The evidence storage container of claim 3, wherein the removable attachment structure is a weak adhesive.

6. The evidence storage container of claim 1, wherein the attachment structure is a permanent attachment structure configured to permanently attach the evidence storage container to the law enforcement vehicle.

7. The evidence storage container of claim 6, wherein the permanent attachment structure is a rivet.

8. The evidence storage container of claim 1, further comprising:
a paper grasp structure.

9. The evidence storage container of claim 8, wherein the paper grasp structure is a slot in either the front wall portion or the at least one side wall portion.

10. The evidence storage container of claim 8, wherein the paper grasp structure is a clip mounted on the evidence storage container.

12. The evidence storage container of claim 1, further comprising:
a lid panel; and
hinge mechanism on the lid.

13. The evidence storage container of claim 12, further comprising:
a security mechanism configured to lock and unlock the lid of the evidence storage container.

14. The evidence storage container of claim 1, further comprising:
one or more drain holes in the front wall portion.

15. The evidence storage container of claim 1, wherein the evidence storage container has a width W across the evidence storage container; and
wherein the evidence storage container is symmetrical with respect to a front view and the front wall portion is centered across the evidence storage container.
